(19) United States
(12) Patent Application Publication
(10) Pub. No.: US 2005/0247865 A1
(43) Pub. Date: Nov. 10, 2005

(54) Status indicator for a controller

(76) Inventors: Eugene J. Takach, Eden Prairie, MN (US); Arnie P. Kalla, Maple Grove, MN (US); Philip O. Readio, Savage, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/841,678

(22) Filed: May 6, 2004

(51) Int. Cl. G01D 5/34

(52) U.S. Cl. 250/239

(57) ABSTRACT

A controller housing for use with a controller that may include a location for a status light emitting source. The controller housing may be adapted to hide from view the location for the status light emitting source when the status light emitting source is not present and/or when the status light emitting source is present but not emitting light, but still allow at least some light emitted by an installed and activated status light emitting source to pass though the wall of the controller housing and be viewed from outside of the housing.

### TECHNICAL FIELD

The present invention relates generally to the field of controllers, and more particularly, to status or other indicators for controllers.

### BACKGROUND

Controllers are used on a wide variety of devices and systems for controlling various functions, including in homes and/or buildings and their related grounds. Some controllers have schedule programming that modifies, for example, device parameter set points as a function of date and/or time. HVAC controllers, for example, are employed to monitor and, if necessary, control various environmental conditions within a home, office, or other enclosed space. Such devices are useful, for example, in regulating any number of environmental conditions within a particular space including for example, temperature, humidity, venting, air quality, etc. The HVAC controller may include a microprocessor or the like that interacts with other components in the system. For example, in many modem thermostats for use in the home, a controller unit equipped with temperature, humidity and/or other sensing capabilities may be provided to interact with a heater, blower, flue vent, air compressor, humidifier and/or other components, to control the temperature, humidity, and/or other environmental conditions at various locations within the home. In one example, a sensor located within the controller unit and/or at one or more remote locations may be employed to sense when the temperature or humidity reaches a certain threshold level, causing the controller unit to send a signal to activate or deactivate one or more component in the HVAC system.

Many of these controllers have one or more status indicators located on the front and/or sides of the controller. In many cases, the status indicator includes a light source such as an LED located on a control board or the like inside the controller. A housing, which extends around and hides the control board from view, often includes an aperture that is aligned with the light source. The aperture is adapted to allow light from the light source to escape and be viewed by the user of the controller. In some cases, the light source extends into the aperture for better viewing. In other cases, the aperture is filled with a transparent material, or some other kind of light pipe, that allows the light from the light source to escape through the non-transparent housing and be viewed by a user.

In many cases, it would be desirable to use the same basic housing for different models of a controller. However, some controller models may include a particular status indicator light source, while others may not. For example, some models may include functionality to control ventilation in a building, while others may not. For the models that include ventilation control, a status light may be provided for indicating when, for example, the ventilation is currently “on”, or that an outside air damper is currently “open”. In many cases, and because various models often include different status indicator lights, more than one controller housing must typically be produced. Increasing the number of controller housing configurations, however, can add significant cost, expense and complexity to the manufacture and inventory management for the controllers.

### SUMMARY

Generally, the present invention relates to controllers, and more particularly, to status or other indicators for controllers. In one illustrative embodiment, a controller housing is provided for a controller, where the controller has a location for a light emitter. In some embodiments, a light emitter may be installed at the location for the light emitter, and in other embodiments, a light emitter is not installed. The controller may be any type of controller including, for example, an HVAC controller, a sprinkler system controller, a security system controller, a lighting system controller, or any other type of controller as desired.

The housing may be fixed relative to the controller, and in some cases, provides an improved appearance to the controller and may hide a controller board or the like. In one illustrative embodiment, the housing includes a wall that has a first region that is adjacent to the location for the light emitter when the housing is fixed to the controller. The first region may be made from, for example, a material that prevents the viewing of the location for the light emitter when the light emitter is not present and/or when the light emitter is present but not emitting light. The material of the first region may also allow at least some of the light emitted by an installed and activated light emitter to pass though the wall of the housing and be viewed from outside of the housing.

In some but not all cases, the wall of the housing at or near the location for the light emitter may be thinned relative to an adjacent portion of the housing to help light emitted by an installed and activated light emitter to diffuse through the thinned portion of the wall and be viewed by a user. In some embodiments, a pattern may be embossed or otherwise provided on the thinned portion of the wall. In such an embodiment, the pattern may be visible from outside of the housing when light emitted by an installed and activated light emitter diffuses through the thinned portion of the wall including the pattern.

The above summary is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a front view of an illustrative controller

FIG. 2 is an exploded perspective view of an illustrative controller;

FIG. 3 is a front perspective view of an illustrative controller housing;

FIG. 4 is a rear perspective view of an illustrative controller housing; and

FIG. 5 is a cross-sectional side elevation view of a portion of an illustrative controller base and controller housing.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

Generally, the present invention relates to controllers that may include one or more status light indicators or the like. These controllers can be used in a variety of systems such as, for example, HVAC systems, sprinkler systems, security systems, lighting systems, and the like. Many of the Figures depict HVAC controllers. While the present invention is not so limited, an appreciation of various aspects of the invention will be gained through a discussion of the examples provided below.

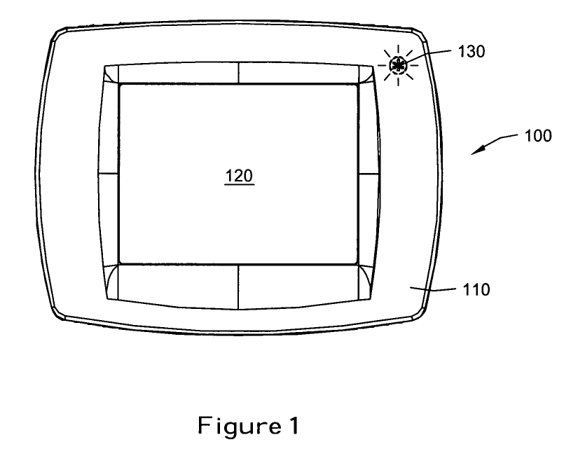

Referring now to FIG. 1, which shows a front view of an illustrative HVAC controller 100. The illustrative HVAC controller 100 can be mounted on a surface, such as a wall for example, and may be operatively connected to one or more system components that can be activated to regulate various environmental conditions such as temperature, humidity and air quality levels occurring within a structure, for example. One or more local and/or remote sensors as well as other system components can also be connected to controller 100 to monitor and regulate the environment, as desired.

The illustrative HVAC controller 100 includes a display 120, a controller housing 110, and one or more status indicators 130. In some embodiments, the display 120 can include, for example, a touch screen, a liquid crystal display (LCD) panel and keypad, a dot matrix display, a computer, and/or any other suitable device for sending and receiving signals and/or messages to and from the controller 100. The display 120 may allow a user to interact with the controller 100. For example, a user via the display may display and/or modify controller parameters or display and/or modify a controller schedule. While the illustrative HVAC controller 100 includes a display 120, it is contemplated that the use of a display 120 is not required or even desired on other illustrative embodiments.

The controller housing 110 can be disposed on or other fixed relative to a controller base to cover internal components such as an internal circuit board or the like of the controller 100. In some embodiments, the controller housing 110 may be a unitary construction formed of any useful material such as, for example, plastic or polymeric materials, but this is not required in all embodiments. In some embodiments, the controller housing 110 can be made from a material that is generally opaque to hide internal controller components but still allow some light to diffuse through the controller housing material by an appropriate status light emitting source located adjacent and under the controller housing 110.

In some embodiments, the controller housing 110 can have a pattern on or in the outer or inner surface of the controller housing adjacent to the location for the status indicator further described below. One or more additional apertures may be present to accommodate touch keys, other status lights, or any other desired component, as desired.

In the illustrative embodiment, a status indicator 130 can be selectively viewable through the controller housing 110 material. The status indicator 130 can be illuminated by any status light emitting source that can emit and diffuse light through the controller housing 110 so that the emitted light is visible to a viewer looking at the controller 110. The status indicator 130 can be illuminated to indicate any number of controller parameters, as desired. More than one status indicator 130 can be disposed in the controller 100 and selectively viewable through the controller housing 110, as desired.

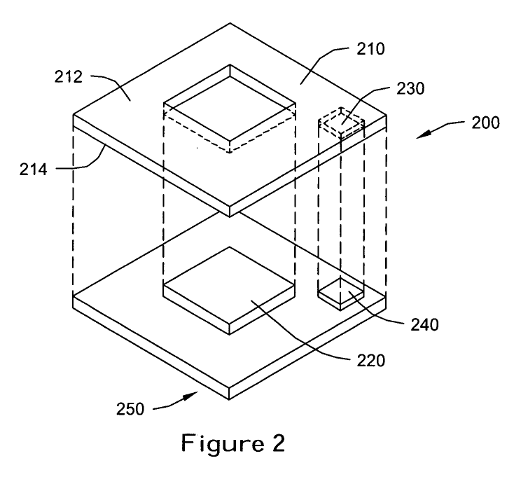

FIG. 2 is an exploded perspective view of an illustrative controller 200. Like the controller 100 of FIG. 1, the illustrative controller 200 includes a display 220 and a controller housing 210. The illustrative controller 200 may also include a controller base 250 as shown. The controller base may, in some embodiments, include a circuit board or the like that includes a location for a status emitting light source. The circuit board or the like may control the activation of the status emitting light source, if desired. The controller housing 210 can have an inner surface 214 and an outer surface 212, and a thickness defined by the distance between the inner surface 214 and the outer surface 212. The thickness need not be uniform across the entire controller housing 210.

In some embodiments, a status light emitting source is not provided at the location for the status light source, while in other embodiments, a status light emitting source 240 is provided. The status light emitting source can be any light source capable of emitting or directing light such as, for example, an LED, a laser diode, a light pipe, or any other suitable light emitting component. When installed, the status light source 240 can be positioned adjacent to a status indicator region 230 of the controller housing 210.

In some embodiments, the status indicator region 230 can have a thickness that is less than the thickness of the region around the status indicator region 230, and in some cases, a thickness that is less than the thickness of the remaining controller housing 210. For example, and in some embodiments, the status indicator region 230 can have a thickness that is, for example, 75% or less of the thickness of the region around the status indicator region 230. In other embodiments, the status indicator region 230 can have a thickness that is 50% or less of the thickness of the region around the status indicator region 230. In yet other embodiments, the status indicator region 230 can have a thickness that is 25% or less of the thickness of the region around the status indicator region 230. The remaining controller 210 housing can have any useful thickness, as desired. In some embodiments, the controller housing 210 can have a thickness of 1 mm to 5 mm, or from 1 mm to 3 mm, for example. While the status indicator region 230 may have a thickness that is less than the region around the status indicator region 230, this is not required in all embodiments.

In some cases, the status indicator region 230 may have a pattern in or on the controller housing 210. In some cases, the pattern may be embossed in or on the inner and/or outer surface of the controller housing 210, as desired. Once the controller housing 210 is disposed on the controller base 250, the controller housing may cover and/or hide the status light source 240 (when present) such that a viewer is unable to see the status light source 240 when viewing from the outer surface 212 of the controller housing 210. However, when the status light source 240 is present and is activated to emit light, the controller housing may be adapted to allow a viewer to see at least some of the emitted light as it diffuses through the thickness of the status indicator region 230 of the controller housing 210. When a pattern is provided on or in the controller housing wall, the emitted light can form a corresponding visible diffuse pattern on the outer surface 212 of the controller housing 210.

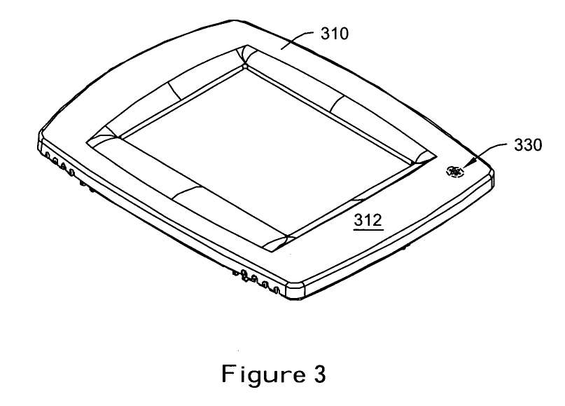

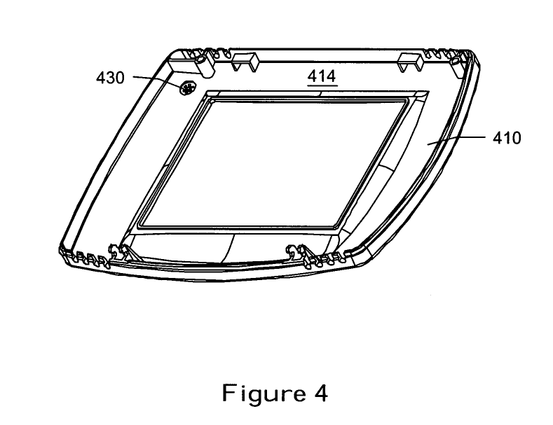

FIG. 3 is a front perspective view of an illustrative controller housing 310. The illustrative controller housing 310 has an outer or front surface 312. A status indicator region 330 is shown and includes a pattern in this illustrative embodiment. When the pattern is illuminated from the back surface 414 (see FIG. 4), the pattern is visible from the front surface 312 of the controller housing 310 as shown.

FIG. 4 is a rear perspective view of an illustrative controller housing 410. The controller housing 410 has an inner or back surface 414. A status indicator region 430 is shown at 430 and includes a pattern embossed on the inner surface 414. When the pattern is illuminated from the back surface 414, the pattern is visible on the front surface 312 (see FIG. 3). Because the pattern is provided on the inner surface 414 in FIG. 4, the pattern may not be visible to a user when the status light source is not present and/or not activated.

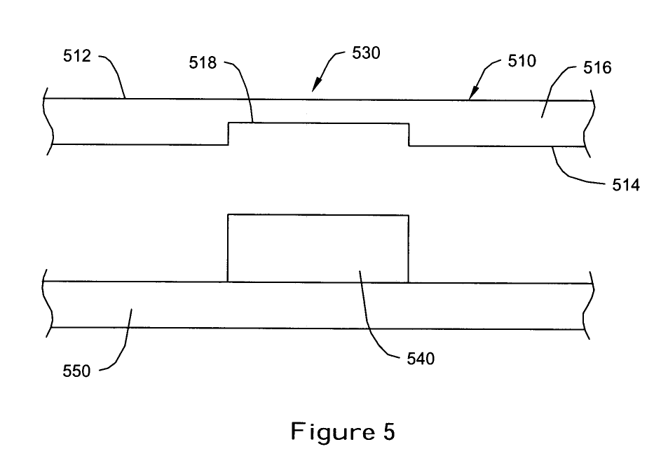

FIG. 5 is a cross-sectional side elevation view of a portion of an illustrative controller base 550 and controller housing 510. In this illustrative embodiment, the controller housing 510 has an outer surface 512 and an inner surface 514. The illustrative controller housing 510 includes a thinner status indicator region 518 adjacent a location for a status light emitting source 540, and a thicker region 516 adjacent to the thinner status indicator region 510. In some embodiments, the thicker region 516 may extend around the perimeter of the thinner status indicator region 518. As can be seen, the thicker region 516 has a thickness that is greater than the thinner status indicator region 518. In some embodiments, the thinner status indicator region 518 and the thicker region 516 may be made from the same material, and may be of a unitary construction. Also, the thicker region 516 may have a sufficient thickness that prevents or substantially prevents sufficient light emitted by the light emitter to pass through the controller housing 510 and be viewed, and the thinner status indicator region 518 may be sufficiently thin to allow sufficient light to pass through the controller housing 510 and be viewed when a status light emitting source 540 is present and activated.

The illustrative embodiment shows a status light source 540 disposed adjacent to the thinner status indicator region, generally designated as 530. The status light source 540 may be disposed or fixed relative to the controller base 550, but this is not required in all embodiments. For example, the status light source 540 may be disposed on or fixed relative to the controller housing 510, if desired.

The controller housing 510 may be made from a material that hides the location for the status light source from view if no light source is present and/or hides the status light source 540 from view when the status light source is present and not emitting light. If a status light source 540 is present, and is activated to illuminate light, the status indicator region 530 may pass at least some of the light such that a viewer can see the emitted status light that diffuses through the status indicator region 530 of the controller housing 510.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

1. A housing for a controller, wherein the controller includes a location for a light emitter, the housing comprising:
a wall having a first region that is adjacent the location for the light emitter when the housing is fixed to the controller, the first region is made from a material that prevents the viewing of the location for the light emitter when the light emitter is not present or when the light emitter is present but not emitting light, and allows at least some of the light emitted by the light emitter to pass though and be viewed, when the light emitter is present and emitting light.

2. The housing of claim 1 wherein the first region includes a pattern that can be viewed when at least some of the light emitted by the light emitter passes through the first region.

3. The housing of claim 1 wherein the wall includes a second region that extends around the first region, the first region of the wall includes a first wall thickness and the second region of the wall includes a second wall thickness, wherein the second wall thickness is greater than the first wall thickness.

4. The housing of claim 3 wherein the first region and the second region are made from the same material.

5. The housing of claim 3 wherein the second wall thickness is adapted to prevent sufficient light emitted by the light emitter, if present, to be viewed.

6. The housing of claim 1 wherein the light emitter includes an LED.

7. The housing of claim 1 wherein the light emitter includes an end of a light pipe.

8. A housing for a controller, wherein the controller includes a location for a light emitter, the housing comprising:
a wall having a first region that is adjacent the location for the light emitter when the housing is fixed to the controller, and a second region that is adjacent to the first region; and
the first region having a first wall thickness and the second region having a second wall thickness, the second wall thickness being greater than the first wall thickness.

9. The housing of claim 8 wherein the first region and the second region are made from the same material.

10. The housing of claim 8 wherein the second region extends around the first region.

11. The housing of claim 8 wherein the light emitter includes an LED.

12. The housing of claim 8 wherein the light emitter includes an end of a light pipe.

13. The housing of claim 8 wherein the first region and the second region are made from a material that prevents the viewing of the location for the light emitter when the light emitter is not present or present and not emitting light.

14. The housing of claim 13 wherein the first wall thickness is adapted to allow at least some of the light emitted by the light emitter, when present, to pass and be viewed.

15. The housing of claim 14 wherein the second wall thickness is adapted to prevent sufficient light emitted by the light emitter, when present, to be viewed.

16. A controller comprising:
a controller having a location for a light emitter;
a controller housing having an inner surface and an outer surface, the controller housing adapted to be fixed relative to the controller with at least part of the inner surface facing the location for the light emitter; and
the controller housing being formed from a material that prevents a user from viewing the location for the light emitter from outside of the outer surface and allows emitted light to diffuse through the controller housing to the outer surface when a light emitter is at the location for the light emitter and activated by the controller.

17. A controller according to claim 16 wherein the controller includes a light emitter at the location for the light emitter, and the controller activates the light emitter to indicate a status of the controller.

18. A controller according to claim 17, wherein the light emitter is a LED.

19. A controller according to claim 16, wherein the controller housing is of a unitary construction.

20. A controller according to claim 16, wherein the controller housing includes a first region having a first thickness and a second region having a second thickness, wherein the first region is adjacent the location for the light emitter, and the first thickness is less than the second thickness.

21. A controller according to claim 20, wherein the first thickness is 75% or less of the second thickness.

22. A controller according to claim 21, wherein the first thickness is 50% or less of the second thickness.

23. A controller according to claim 22, wherein the first thickness is 25% or less of the second thickness.

24. A controller according to claim 20, wherein the first region includes a pattern.

25. A controller according to claim 24, wherein the pattern is on the inner surface of the controller housing and is only visible from outside the controller housing when the light emitter is activated.

26. A controller comprising:
a controller having a status light source, the status light source configured to emit status light to indicate a status of the controller;
a controller housing fixed relative to the controller, the controller housing having a thicker region of a first thickness and a thinner region of a second thickness, wherein the first thickness is greater than the second thickness, the thinner region being adjacent the status light source when the controller housing is fixed to the controller, the controller housing being adapted to hide the status light source when the status light source is not activated and allows emitted status light to diffuse through the thinner region when the status light source is activated.

27. A controller according to claim 26, wherein the controller is an HVAC controller.

28. A controller according to claim 26, wherein the controller housing has a front surface with a first thickness of from 1 mm to 3 mm.

29. A controller according to claim 28, wherein the second thickness is 75% or less of the first thickness.

30. A controller according to claim 29, wherein the second thickness is 50% or less of the first thickness.

31. A controller according to claim 30, wherein the second thickness is 25% or less of the first thickness.

32. The controller according to claim 12, wherein the thinner region includes a pattern.

33. A controller according to claim 32, wherein the pattern is visible only when the status light source is activated.

34. A method for providing a controller, the method comprising the steps of:
providing a controller having a location for a light emitter;
providing a controller housing, wherein the controller housing includes a wall with a first region that, when the controller housing is fixed to the controller, the first region is adjacent the location for the light emitter, the first region being formed from a material that prevents the viewing of the location for the light emitter when the light emitter is not present or when the light emitter is present but not emitting light, and allows at least some of the light emitted by the light emitter to pass though and be viewed, when the light emitter is present and emitting light; and
fixing the controller housing to the controller.

35. A method according to claim 34 further comprising the step of:
providing a light emitter at the location for the light emitter prior to fixing the controller housing to the controller.

36. A method according to claim 34 wherein the controller is an HVAC controller.

37. A method of illuminating a status indicator on a controller comprising the steps of:
providing a controller having a status light source and a controller housing having an inner surface adjacent to the status light source and an outer surface, wherein the controller housing is adapted to hide the status light source when the status light source is inactive; and
activating the status light source to illuminate the inner surface and diffuse light to the outer surface of the controller housing adjacent to the status light source.

38. A method according to claim 37 wherein the controller is an HVAC controller.
